(19) United States
(12) Patent Application Publication
(10) Pub. No.: US 2006/0188224 A1
(43) Pub. Date: Aug. 24, 2006

(54) Method and apparatus for recording information on a recording disc

(75) Inventor: Yoshihiro Matsunaga, Sagamihara-shi (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/283,774

(22) Filed: Nov. 22, 2005

(30) Foreign Application Priority Data
Feb. 21, 2005 (JP) 2005-043661

(51) Int. Cl. H04N 7/52

(52) U.S. Cl. 386/95

(57) ABSTRACT

A program stream is generated from input video data. A recording area is secured in a first track on a recording disc. Video object sets are generated from the program stream. The video object sets are recorded on a second track on the recording disc. The second track is separate from the first track. Video title management information pieces are generated which correspond to the video object sets respectively. The video title management information pieces are recorded on the secured recording area. Preferably, the video object sets are recorded on the second track while the video title management information pieces are recorded on the secured recording area.

### BACKGROUND OF THE INVENTION

1. Field of the Invention

This invention generally relates to a method and an apparatus for recording information on a recording disc. This invention particularly relates to a method and an apparatus for sequentially recording real-time information on a recording disc such as a DVD (digital versatile disc).

2. Description of the Related Art

DVDs (digital versatile discs) include ones conforming with the DVD-Video standards which concern the recording and reproduction of video and audio data. DVDs are of several types such as a read-only type, a recordable type, and a rewritable type.

International patent application publication number WO 00/30112 corresponding to Japanese patent application publication number (Toku-Hyo) 2002-530800 discloses a device for recording video on a DVD. In patent application WO 00/30112, the information in the recorded video is arranged according to a recording format. The video information in the recorded video is subdivided into cells, and playback parameters for reproducing sequences of the cells are included in control information. The recording format prescribes that within a recording area of the DVD, the control information should precede the video information for playback functions of the recorded video. For home recording, it is preferable that the recording is made in one pass, i.e., the video is recorded directly at its final location. Therefore, a recorder in the recording device has a control unit for performing the following steps: first creating a free area in the DVD by selecting a starting point within the recording area different from the beginning of the recording area, thereafter recording the real-time video information from the starting point, and finally recording the control information in the free area.

The recording device in patent application WO 00/30112 can sequentially record a plurality of video title sets (VTS#1, VTS#2, . . . ) on a DVD. Specifically, a usable sub-area for a video manager (VMG) and a usable sub-area for video title set information (VTSI#1) are successively provided at a head of the recording area in the DVD. Then, a video object set (VOBS#1) is recorded on a portion of the recording area which follows the usable sub-area for the VTSI#1. Thereafter, the VTSI#1 is recorded on the usable sub-area for the VTSI#1, and is also recorded on a portion of the recording area which follows the recorded VOBS#1 as backup video title set information (VTSI#1_BUP). The recorded VTSI#1, VOBS#1, and VTSI#1_BUP constitute a recorded VTS#1. Subsequently, a usable sub-area for video title set information (VTSI#2) is provided at a portion of the recording area which follows the recorded VTSI#1_BUP. Then, a video object set (VOBS#2) is recorded on a portion of the recording area which follows the usable sub-area for the VTSI#2. Thereafter, the VTSI#2 is recorded on the usable sub-area for the VTSI#2, and is also recorded on a portion of the recording area which follows the recorded VOBS#2 as backup video title set information (VTSI#2_BUP). The recorded VTSI#2, VOBS#2, and VTSI#2_BUPconstitute a recorded VTS#2. The above operation steps are iterated for each of later video title sets. After all the video title sets are recorded on the DVD, the VMG is recorded on the usable sub-area for the VMG. As a result, the recording of the video title sets on the DVD is finalized.

During the sequentially recording of a plurality of video title sets (VTS#1, VTS#2, . . . ) on a DVD by the recording device in patent application WO 00/30112, a usable sub-area for video title set information (VTSI) is repetitively provided in the recording area of the DVD. Thus, the sequentially recording of a plurality of video title sets on a DVD requires a lot of divided zones (referred to as “Rzones” or tracks) to be provided in the recording area of the DVD. Specifically, the sequentially recording of “n” video title sets requires at least “2n+1” Rzones. Generally, the number of Rzones in a DVD has a predetermined upper limit. In the event that the required number of Rzones in a DVD regarding the recording of video title sets thereon exceeds the upper limit, later one or ones of the vide title sets can not be recorded. Accordingly, the recording device in patent application WO 00/30112 is unsuited for the recording of many video title sets on a DVD.

### SUMMARY OF THE INVENTION

It is a first object of this invention to provide an apparatus for recording information on a recording disc which is suited to the recording of many video title sets.

It is a second object of this invention to provide a method of recording information on a recording disc which is suited to the recording of many video title sets.

A first aspect of this invention provides an apparatus for recording information on a recording disc. The apparatus comprises first means for generating a program stream from input video data; second means for securing a recording area in a first track on the recording disc; third means for generating video object sets from the program stream generated by the first means; fourth means for recording the video object sets generated by the third means on a second track on the recording disc, the second track being separate from the first track; fifth means for generating video title management information pieces corresponding to the respective video object sets generated by the third means; and sixth means for recording the video title management information pieces generated by the fifth means on the recording area secured by the second means.

A second aspect of this invention is based on the first aspect thereof, and provides an apparatus wherein the fourth means records the video object sets on the second track while the sixth means records the video title management information pieces on the recording area secured by the second means.

A third aspect of this invention is based on the first aspect thereof, and provides an apparatus wherein the fourth means records the video object sets on the second track before the sixth means records the video title management information pieces on the recording area secured by the second means.

A fourth aspect of this invention is based on the first aspect thereof, and provides an apparatus further comprising seventh means for securing a recording area in a third track on the recording disc, the third track being separate from the first and second tracks; eighth means for generating a video manager related to the recorded video object sets and the recorded video title management information pieces; and ninth means for recording the video manager generated by the eighth means on the recording area secured by the seventh means.

A fifth aspect of this invention provides a method of recording information on a recording disc. The method comprises the steps of a) generating a program stream from input video data; b) securing a recording area in a first track on the recording disc; c) generating video object sets from the program stream generated by the step a); d) recording the video object sets generated by the step c) on a second track on the recording disc, the second track being separate from the first track; e) generating video title management information pieces corresponding to the respective video object sets generated by the step c); and f) recording the video title management information pieces generated by the step e) on the recording area secured by the step b).

A sixth aspect of this invention is based on the fifth aspect thereof, and provides a method wherein the step d) records the video object sets on the second track while the step f) records the video title management information pieces on the recording area secured by the step b).

A seventh aspect of this invention is based on the fifth aspect thereof, and provides a method wherein the step d) records the video object sets on the second track before the step f) records the video title management information pieces on the recording area secured by the step b).

An eighth aspect of this invention is based on the fifth aspect thereof, and provides a method further comprising the steps of g) securing a recording area in a third track on the recording disc, the third track being separate from the first and second tracks; h) generating a video manager related to the recorded video object sets and the recorded video title management information pieces; and i) recording the video manager generated by the step h) on the recording area secured by the step g).

The apparatus and the method in this invention have the following advantage. The apparatus and the method can sequentially record VTSs (video title sets), the number of which is greater than the upper limit number prescribed by the DVD-Video standards, on a recording disc such as a DVD.

### BRIEF DESCRIPTION OF THE DRAWINGS

FIG. 1 is a diagram of an example of the logical data structure of a video and audio data area in a DVD which conforms with the DVD-Video standards.

FIG. 2 is a block diagram of a recording apparatus according to a first embodiment of this invention.

FIG. 3 is a diagram of the recording apparatus in FIG. 2.

FIG. 4 is a diagram of an example of the logical data structure of a video and audio data area in a DVD which results from the sequentially recording of “n” VTSs thereon by the recording apparatus of FIGS. 2 and 3.

FIG. 5 is a diagram of an example of the prior-art logical data structure of a video and audio data area in a DVD which results from the sequentially recording of “n” VTSs thereon by a prior-art recording apparatus.

FIG. 6 is a diagram of conditions of a video and audio data area in a DVD which occur at different stages during the sequentially recording of “n” VTSs thereon by the recording apparatus of FIGS. 2 and 3.

FIG. 7 is a flowchart of a segment of a control program for a recording signal processor and a controller in FIGS. 2 and 3.

### DETAILED DESCRIPTION OF THE INVENTION

A conventional DVD format and prior-art recording apparatuses will be explained below for a better understanding of this invention.

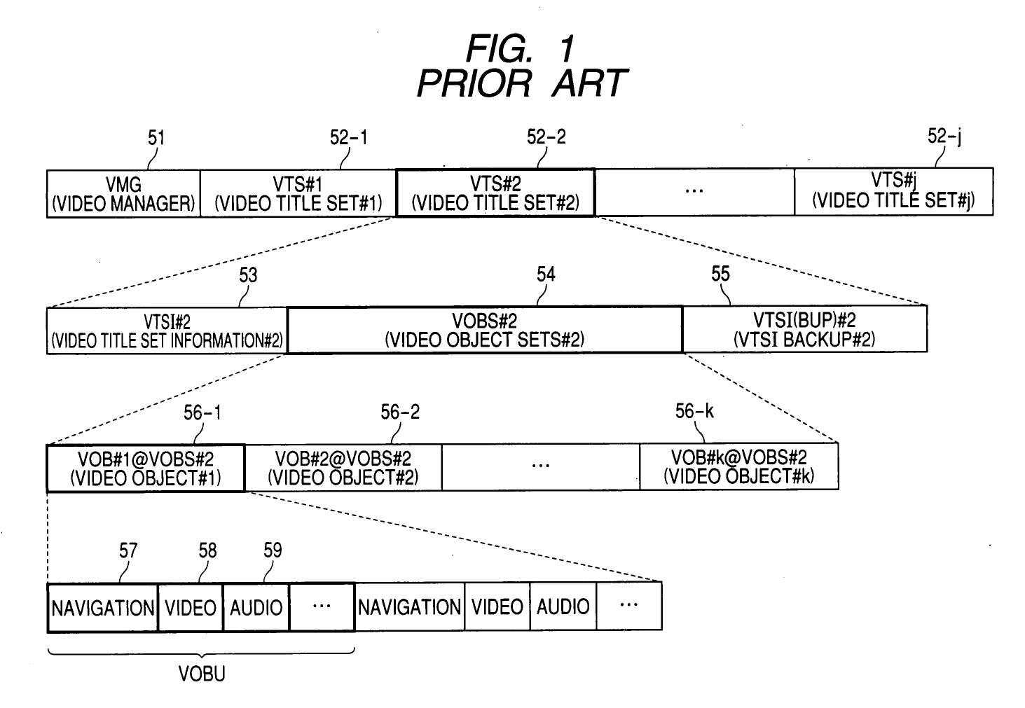

FIG. 1 shows an example of the logical data structure of a video and audio data area in a DVD which conforms with the DVD-Video standards. The video and audio data area stores not only pure video and audio data but also other data necessary for the playback of the contents of the pure video and audio data. The video and audio data area is of a hierarchical structure.

As shown in FIG. 1, the first layer in the video and audio data area stores a VMG (video manager) 51 and VTSs (video title sets) 52-1, 52-2, . . . , and 52-j, where “j” denotes the total number of video titles. The VTSs 52-1, 52-2, . . . , and 52-j are also numbered as VTS#1, VTS#2, . . . , and VTS#j, respectively. The VMG 51 has a packet loaded with management information for the whole of the video and audio area in the DVD. Specifically, the VMG 51 includes control and playback information for the entire DVD, that is, information for controlling the VTSs 52-1, 52-2, . . . , and 52-j. The VMG 51 is divided into sections (not shown) referred to as multiple files.

Each VTS 52 is composed of a VTSI (video title set information) section 53, a VOBS (video object set) section 54, and a VTSI(BUP) section 55. The VTSI section 53 has management information, that is, video title set information (VTSI), related to the corresponding VTS 52. The VTSI(BUP) section 55 has backup data for the management information in the VTSI section 53. The backup data is identical in contents to the management information. The VOBS section 54 has video and audio data. The VOBS section 54 may also have data representing menu contents.

As shown in FIG. 1, the VOBS section 54 has a set of VOBs (video objects) 56-1, 56-2, . . . , and 56-k, where “k” denotes a given natural number. The VOBs 56-1, 56-2, . . . , and 56-k are loaded with video and audio data only. The VOBs 56-1, 56-2, . . . , and 56-k are also numbered as VOB#1, VOB#2, . . . , and VOB#k, respectively.

Each VOB 56 has a plurality of VOBUs (video object units). Each VOB 56 may have a set of video cells (not shown) each containing a plurality of VOBUs. Each VOBU is a group of a navigation section 57, video sections 58 (only one of which is shown), and audio sections 59 (only one of which is shown). The navigation section 57 is a navigation pack. The video sections 58 are video packs. The audio sections 59 are audio packs. The navigation section 57 has navigation information used at the time of the playback of the contents of the video and audio data. The navigation information includes playback management information, search information (VOBU search information), and ending time information (VOB video display ending time information). Each video section 58 has encoded video data. Each audio section 59 has encoded audio data. The search information and the ending time information in the navigation section 57 mean search information (VOBU_SRI) for the related VOBU and ending time information (VOB_V_E_PTM in SML_PBI) for the related VOB 56. The navigation information in the navigation section 57 or the playback management information therein contains VOB identifier information and VOB start address information.

A first prior-art apparatus designed to record data on a DVD operates as follows. The first prior-art apparatus provides the DVD with a video and audio data area having the logical data structure of FIG. 1. The first prior-art apparatus provides or secures a recording region on the DVD for a VMG 51 before sequentially implementing the following steps concerning one or more VTSs 52. Specifically, the first prior-art apparatus provides or secures a recording region on the DVD for a VTSI section 53. Subsequently, the first prior-art apparatus records data on the DVD to form a VOBS section 54 which follows the secured recording region for the VTSI section 53. After the recording of data to form the VOBS section 54 has been completed, the first prior-art apparatus records video title set information (VTSI) on the secured recording region to form a VTSI section 53. Then, the first prior-art apparatus records backup data on the DVD to form a VTSI(BUP) section 55. The backup data is the same as the VTSI. After the recording of data and information concerning all the VTSs 52 has been completed, the first prior-art apparatus records management information for the whole of the video and audio area on the secured recording region for the VMG 51.

Specifically, the recording of data concerning each VOB 56 is as follows. The first prior-art apparatus prepares video and audio data to be assigned to video sections 58 and audio sections 59 in the VOB 56. Thereafter, the first prior-art apparatus generates search information and other information which correspond to the prepared video and audio data, and which should be assigned to a navigation section 57. Then, the first prior-art apparatus combines the generated search information and other information, and the prepared video and audio data into a format corresponding to the data structure concerning the VOB 56. Subsequently, the first prior-art apparatus records the combination of the search information and other information, and the video and audio data on the DVD to form the VOB 56.

As previously mentioned, in the first prior-art apparatus, search information and other information are generated after video and audio data have been prepared. The first prior-art apparatus includes a storage device such as a memory or a hard disk. The first prior-art apparatus implements a 2-pass recording procedure in which data corresponding to an image of each VOB 56 is provided in the storage device before being transferred therefrom and being recorded on the DVD to form the VOB 56.

A second prior-art apparatus designed to record data on a DVD is disclosed in International patent application publication number WO 00/30112 corresponding to Japanese patent application publication number (Toku-Hyo) 2002-530800. The data recording by the second prior-art apparatus is made in one pass, i.e., the data is recorded directly at its final location. Specifically, the second prior-art apparatus performs the following steps: first creating a free area in the DVD by selecting a starting point within the recording area different from the beginning of the recording area, thereafter recording the real-time video information from the starting point, and finally recording the control information in the free area.

The second prior-art apparatus can sequentially record a plurality of video title sets (VTS#1, VTS#2, . . . ) on a DVD. Specifically, a usable sub-area for a video manager (VMG) and a usable sub-area for video title set information (VTSI#1) are successively provided at a head of the recording area in the DVD. Then, a video object set (VOBS#1) is recorded on a portion of the recording area which follows the usable sub-area for the VTSI#1. Thereafter, the VTSI#1 is recorded on the usable sub-area for the VTSI#1, and is also recorded on a portion of the recording area which follows the recorded VOBS#1 as backup video title set information (VTSI#1_BUP). The recorded VTSI#1, VOBS#1, and VTSI#1_BUP constitute a recorded VTS#1. Subsequently, a usable sub-area for video title set information (VTSI#2) is provided at a portion of the recording area which follows the recorded VTSI#1_BUP. Then, a video object set (VOBS#2) is recorded on a portion of the recording area which follows the usable sub-area for the VTSI#2. Thereafter, the VTSI#2 is recorded on the usable sub-area for the VTSI#2, and is also recorded on a portion of the recording area which follows the recorded VOBS#2 as backup video title set information (VTSI#2_BUP). The recorded VTSI#2, VOBS#2, and VTSI#2_BUPconstitute a recorded VTS#2. The above operation steps are iterated for each of later video title sets. After all the video title sets have been recorded on the DVD, the VMG is recorded on the usable sub-area for the VMG. As a result, the recording of the video title sets on the DVD is finalized.

During the sequentially recording of a plurality of video title sets (VTS#1, VTS#2, . . . ) on a DVD by the second prior-art apparatus, a usable sub-area for video title set information (VTSI) is repetitively provided in the recording area of the DVD. Thus, the sequentially recording of a plurality of video title sets on a DVD requires a lot of divided zones (referred to as “Rzones” or tracks) to be provided in the recording area of the DVD. Specifically, the sequentially recording of “n” video title sets requires at least “2n+1” Rzones. Generally, the number of Rzones in a DVD has a predetermined upper limit. In the event that the required number of Rzones in a DVD regarding the recording of video title sets thereon exceeds the upper limit, later one or ones of the vide title sets can not be recorded. Accordingly, the second prior-art apparatus is unsuited for the recording of many video title sets on a DVD.

### First Embodiment

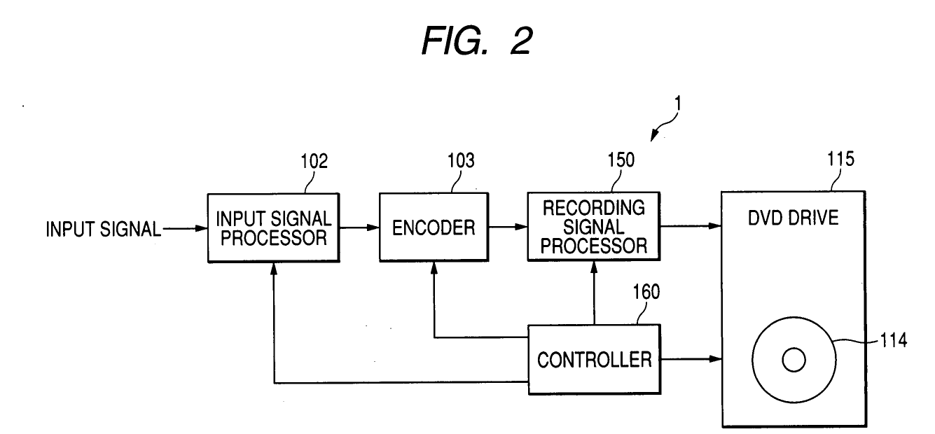

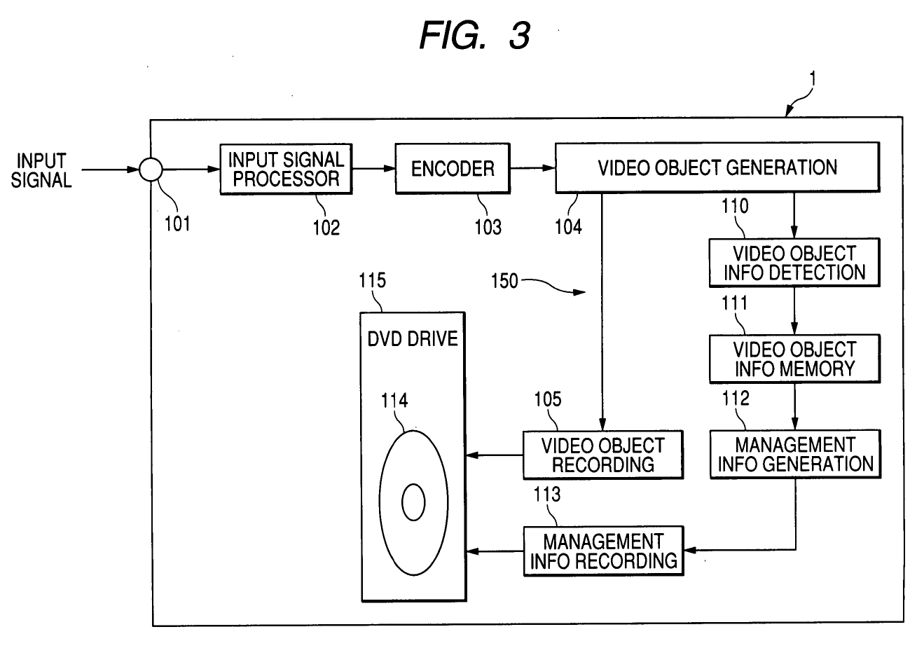

FIGS. 2 and 3 show an apparatus 1 for sequentially recording contents data on a DVD 114 according to a first embodiment of this invention. The contents data includes at least one of video data, audio data, and audio-visual data. The DVD 114 is of, for example, a rewritable type or a recordable type.

As shown in FIGS. 2 and 3, the recording apparatus 1 includes an input signal processor 102, an encoder 103, a recording signal processor 150, and a DVD drive device 115 for the DVD 114 which are sequentially connected in that order. The recording apparatus 1 further includes a controller 160 connected with the devices 102, 103, 115, and 150. The controller 160 serves to control the devices 102, 103, 115, and 150. The DVD 114 can be placed into and removed from the DVD drive device 115.

An external device (not shown) feeds an input signal to the input signal processor 102 via an input terminal 101. The input signal is a video signal, an audio signal, or an audio-visual signal. For example, the input signal has a set of an analog composite video signal and an analog stereophonic audio signal.

The input signal processor 102 is controlled by the controller 160 to subject the input signal to format conversion including analog-to-digital conversion. Thereby, the input signal processor 102 converts the input signal into a digital signal. The input signal processor 102 outputs the digital signal to the encoder 103. For example, in the case where the input signal has a set of an analog composite video signal and an analog stereophonic audio signal, the input signal processor 102 converts the analog composite video signal and the analog stereophonic audio signal into digital color-difference data and digital audio data.

The encoder 103 converts the output signal of the input signal processor 102 into a data stream (a program stream) through an encoding procedure while being controlled by the controller 160. The encoder 103 outputs the data stream to the recording signal processor 150. For example, in the case where the output signal of the input signal processor 102 has a set of digital color-difference data and digital audio data, the encoder 103 subjects the digital color-difference data to MPEG2 encoding to get MPEG2 video data and subjects the digital audio data to AC-3 encoding to get AC-3 audio data. Then, the encoder 103 combines the MPEG2 video data and the AC-3 audio data into a program stream.

The recording signal processor 150 receives the program stream (the data stream) from the encoder 103. The recording signal processor 150 is controlled by the controller 160 to convert the program stream into a signal to be recorded which has a prescribed format. The recording signal processor 150 outputs the signal to be recorded to the DVD drive device 115. The recording signal processor 150 controls the DVD drive device 115 in response to commands from the controller 160. The DVD drive device 115 records the output signal of the recording signal processor 150 on the DVD 114 therein while being controlled by the recording signal processor 150 and the controller 160.

The recording signal processor 150 and the controller 160 include a digital signal processor, a microcomputer, or a similar device having a combination of an input/output port, a processing section, a ROM, and a RAM. The recording signal processor 150 and the controller 160 operate in accordance with a control program (a computer program) stored in the ROM or the RAM. The control program is designed to enable the recording signal processor 150 and the controller 160 to execute operation steps indicated hereafter.

It should be noted that the recording signal processor 150 and the controller 160 may be signal processing and control portions of a personal computer. In this case, the DVD drive device 115 uses one mounted on the personal computer.

FIG. 3 shows a flow of operation of the recording signal processor 150 rather than the hardware structure thereof. With reference to FIG. 3, there are blocks in the recording signal processor 150. The blocks will be described below.

A video object generating block 104 in the recording signal processor 150 processes the program stream outputted from the encoder 103. Specifically, the video object generating block 104 produces a VOBS (video object set) from the program stream for every VTS (video title set). In more detail, the video object generating block 104 generates VOBs (video objects) in response to the program stream and combines the generated VOBs into a VOBS for every VTS. The video object generating block 104 transmits the produced VOBS to a video object recording block 105 on a VOB-by-VOB basis.

The video object recording block 105 passes the VOBS from the video object generating block 104 to the DVD drive device 115. At the same time, the video object recording block 105 controls the DVD drive device 115 to sequentially record the VOBs, which are transmitted from the video object generating block 104, on the DVD 114.

A video object information detecting block 110 in the recording signal processor 150 extracts video object information from the VOBS produced by the video object generating block 104. The video object information is composed of time information, address information, and discontinuous point information. A video object information memory block 111 temporarily stores the video object information provided by the video object information detecting block 110.

For every VTS, a management information generating block 112 produces VTSI (video title set information) and VTSI(BUP) from the video object information stored by the video object information memory block 111. The VTSI is management information or control information for the VOBS in the related VTS. The VTSI(BUP) means a backup of the VTSI. Therefore, the VTSI(BUP) is identical in contents with the VTSI. The management information generating block 112 transmits the produced VTSI and VTSI(BUP) to a management information recording block 113.

The management information recording block 113 passes the VTSI and the VTSI(BUP) from the management information generating block 112 to the DVD drive device 115. At the same time, the management information recording block 113 controls the DVD drive device 115 to record the VTSI and the VTSI(BUP) on prescribed places in the DVD 114 respectively. In this way, one VTS (video title set) composed of a VOBS, VTSI, and VTSI(BUP) is recorded on the rewritable disc 114.

The recording apparatus 1 can sequentially record “n” VTSs on the DVD 114, where “n” denotes a natural number equal to or greater than 2. The recording of every VTS on the DVD 114 is on a real-time basis.

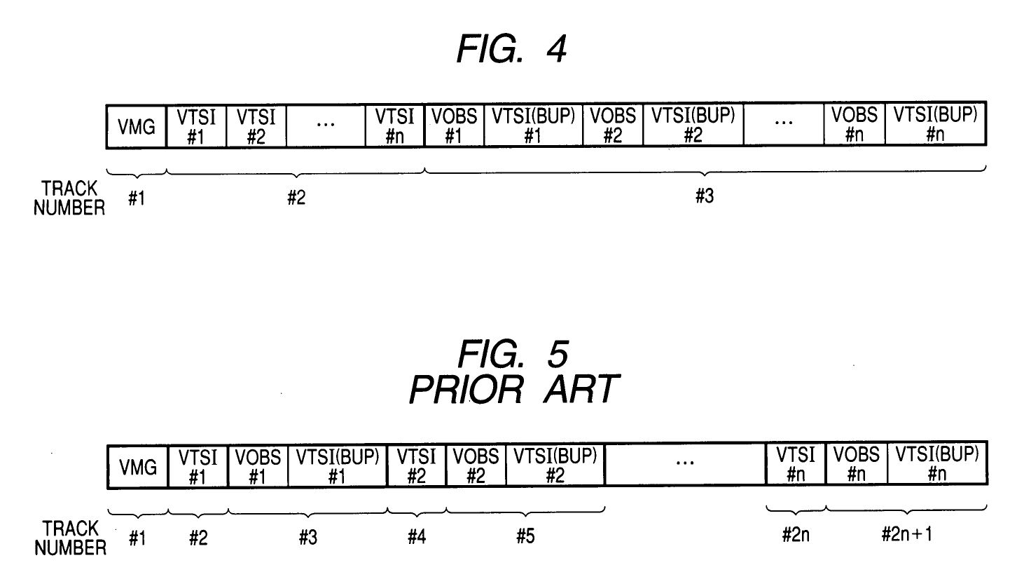

FIG. 4 shows an example of the logical data structure of a video and audio data area in the DVD 114 which results from the sequentially recording of “n” VTSs thereon by the recording apparatus 1. The video and audio data area stores not only pure video and audio data but also other data necessary for the playback of the contents of the pure video and audio data. The video and audio data area is of a hierarchical structure. It should be noted that only the two uppermost layers (the first and second layers) in the hierarchical structure is shown in FIG. 4.

As shown in FIG. 4, the first and second layers in the video and audio data area on a DVD 114 have a VMG (video manager) zone, a succession of VTSI zones, and an alternation of VOBS zones and VTSI(BUP) zones. The VMG zone is followed by the succession of VTSI zones. The succession of VTSI zones is followed by the alternation of VOBS zones and VTSI(BUP) zones. The VMG zone stores a VMG including a packet loaded with management information for the whole of the video and audio area. Specifically, the VMG includes management information for the entire DVD 114, that is, control and playback information for the entire DVD 114 or information for controlling all the recorded “n” VTSs. The VTSI zones correspond to the “n” VTSs, respectively. Each of the VTSI zones is loaded with VTSI of a related VTS. The VOBS zones correspond to the “n” VTSs, respectively. Each of the VOBS zones is loaded with a VOBS of a related VTS. The VTSI(BUP) zones correspond to the “n” VTSs, respectively. Each of the VTSI(BUP) zones is loaded with VTSI(BUP) of a related VTS.

As shown in FIG. 4, the VMG zone is assigned to a first track #1, that is, a first Rzone #1, on the DVD 114. The succession of VTSI zones is assigned to a second track #2, that is, a second Rzone #2, in the DVD 114. The alternation of VOBS zones and VTSI(BUP) zone is assigned to a third track #3, that is, a third Rzone #3, in the DVD 114. The first, second, and third tracks #1, #2, and #3 are separate from each other. Accordingly, only three tracks (three Rzones) are used in the case where the “n” VTSs are recorded on the DVD 114.

Basically, the recorded data structure in FIG. 4 conforms with the DVD-Video standards.

FIG. 5 shows an example of the prior-art logical data structure of a video and audio data area in a DVD which results from the sequentially recording of “n” VTSs thereon by a prior-art recording apparatus. As shown in FIG. 5, the prior-art design uses “2n+1” tracks (Rzones) for the recording of the “n” VTSs on the DVD.

It is understood from the comparison between FIG. 4 and FIG. 5 that the recording apparatus 1 requires a smaller number of tracks (Rzones) on a DVD than that required by the prior-art design for the recording of plural VTSs on the DVD.

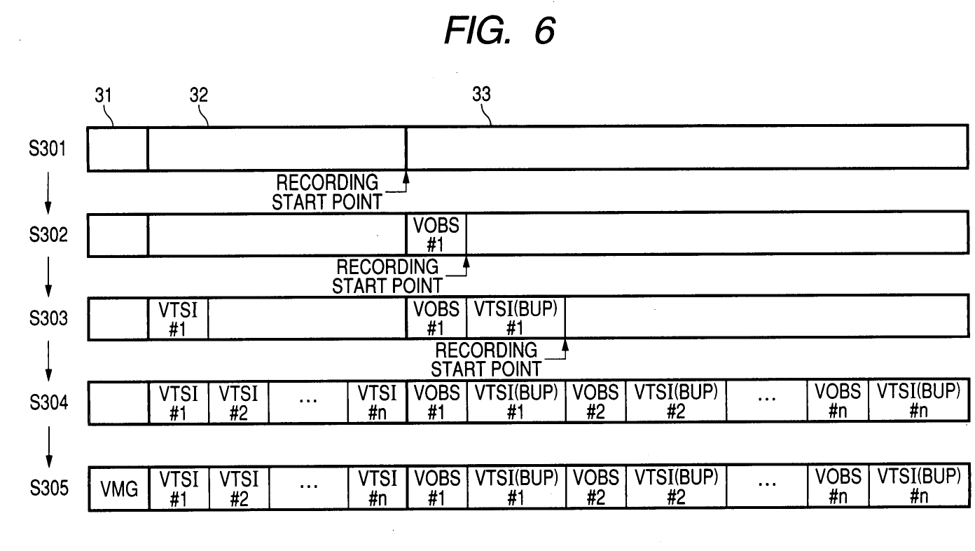

In the case of the sequentially recording of “n” VTSs on a DVD 114, the recording apparatus 1 operates as follows. With reference to FIG. 6, at a stage S301, the recording apparatus 1 provides or secures a recording region 31 for a VMG and a recording region 32 for “n” VTSI in the DVD 114. In addition, the recording apparatus 1 sets a recording start point for a VOBS#1 (a first VOBS) at an on-disc point immediately following the end of the secured recording region 32. The VOBS#1 corresponds to a first VTS (a VTS#1). The secured recording region 32 is followed by a remaining usable region 33 in the DVD 114. At this time, the recording start point exists on the boundary between the secured recording region 32 and the remaining usable region 33.

At a stage S302 subsequent to the stage S301, the recording apparatus 1 records the VOBS#1 on the usable region 33 in the DVD 114 from the recording start point. In addition, the recording apparatus 1 updates the recording start point into coincidence with an on-disc point immediately following the end of the VOBS#1 recording portion of the DVD 114.

At a stage S303 subsequent to the stage S302, the recording apparatus 1 records VTSI#1 (first VTSI) on a head of the secured recording region 32. In addition, the recording apparatus 1 records VTSI(BUP)#1, that is, first VTSI(BUP), on the usable region 33 in the DVD 114 from the recording start point. Furthermore, the recording apparatus 1 updates the recording start point into coincidence with an on-disc point immediately following the end of the VTSI(BUP)#1 recording portion of the DVD 114. The VTSI#1 corresponds to the VOBS#1. Specifically, the VTSI#1 is management information or control information for the VOBS#1. The VTSI(BUP)#1 is a backup of the VTSI#1.

The recording of the VOBS#1, the VTSI#1, and the VTSI(BUP)#1 on the DVD 114 means the recording of the VTS#1 thereon. At a stage S304 subsequent to the stage S303, the recording apparatus 1 sequentially records VTS#2-VTS#n (second and later VTSs) on the DVD 114. The way of recording each of the VTS#2-VTS#n is similar to that of recording the VTS#1. For example, the recording apparatus 1 records a VOBS#2 (a second VOBS) on the usable region 33 in the DVD 114 from the recording start point. In addition, the recording apparatus 1 updates the recording start point into coincidence with an on-disc point immediately following the end of the VOBS#2 recording portion of the DVD 114. The VOBS#2 corresponds to a second VTS (a VTS#2). Then, the recording apparatus 1 records VTSI#2 (second VTSI) on a head of the unoccupied portion or the usable portion of the secured recording region 32. In addition, the recording apparatus 1 records VTSI(BUP)#2, that is, second VTSI(BUP), on the usable region 33 in the DVD 114 from the recording start point. Furthermore, the recording apparatus 1 updates the recording start point into coincidence with an on-disc point immediately following the end of the VTSI(BUP)#2 recording portion of the DVD 114. The VTSI#2 corresponds to the VOBS#2. Specifically, the VTSI#2 is management information or control information for the VOBS#2. The VTSI(BUP)#2 is a backup of the VTSI#2.

At a stage S305 subsequent to the stage S304, the recording apparatus 1 records the VMG on the secured recording region 31. As a result, the recording of the “n” VTSs on the DVD 114 is finalized.

It is preferable to previously decide an expected maximum number of VTSs recorded on a DVD 114. In this case, the size of the VTSI recording region 32 is chosen depending on the expected maximum number of recorded VTSs. When the number of actually recorded VTSs is smaller than the expected maximum number, an unused portion remains in the VTSI recording region 32. Such an unused portion will not cause any problem in the reproduction of the recorded contents data from the DVD 114.

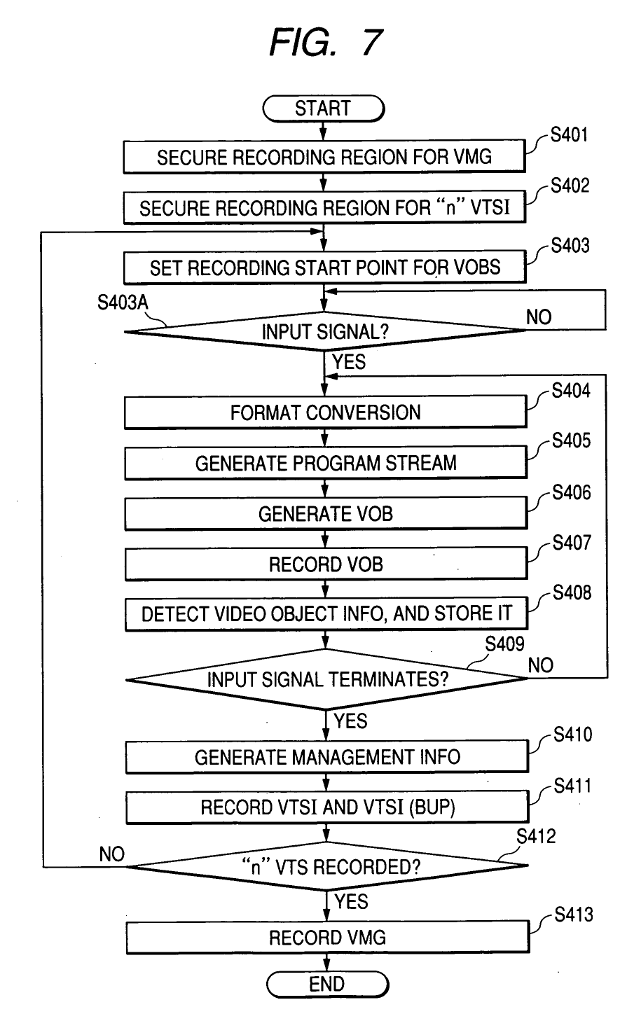

As previously mentioned, the recording signal processor 150 and the controller 160 operate in accordance with the control program stored in the internal ROM or the internal RAM. FIG. 7 is a flowchart of a segment of the control program for sequentially recording VTSs (video title sets) on a DVD 114. The program segment is started when a DVD 114 is placed in the DVD drive device 115 and the recording apparatus 1 is changed to a recording mode of operation.

As shown in FIG. 7, a first step S401 of the program segment executes initialization. Specifically, the step S401 controls the DVD drive device 115 to provide or secure a recording region on the DVD 114 for a VMG (video manager).

A step S402 following the step S401 controls the DVD drive device 115 to provide or secure a recording region on the DVD 114 for “n” VTSI (video title set information). After the step S402, the program advances to a step S403.

The step S403 controls the DVD drive device 115 to decide an on-disc recording start point for a VOBS (video object set). In the case where a VOBS is of a first VTS, the decided on-disc recording start point immediately follows the end of the secured recording region for “n” VTSI. In the case where a VOBS is of a second or later VTS, the decided on-disc recording start point immediately follows the end of the region which stores VTSI(BUP) of the immediately-preceding VTS. After the step S403, the program advances to a step S403A.

The step S403A accesses the input signal processor 102 to determine whether or not an input signal corresponding to one VTS comes thereto. When an input signal comes to the input signal processor 102, the program advances from the step S403A to a step S404. Otherwise, the step S403A is repeated. Thus, a stand-by state is continued until an input signal comes to the input signal processor 102.

It is assumed that the input signal has a set of an analog video signal and an analog audio signal, for example, an analog composite video signal and an analog stereophonic audio signal.

The step S404 controls the input signal processor 102 to subject the input signal to format conversion including analog-to-digital conversion. Thereby, the input signal is converted into a digital signal of a prescribed format suitable to be processed by the encoder 103. The digital signal is transmitted from the input signal processor 102 to the encoder 103.

A step S405 following the step S404 controls the encoder 103 to encode video components of the digital signal in conformity with the MPEG2 standards to get encoded video data. In addition, the step S405 controls the encoder 103 to encode audio components of the digital signal in conformity with the linear PCM standards, the Dolby AC-3 standards, or the MPEG Audio standards to get encoded audio data. Furthermore, the step S405 controls the encoder 103 to combine the encoded video data and the encoded audio data into a program stream (a data stream). The program stream is transmitted from the encoder 103 to the recording signal processor 150.

A step S406 subsequent to the step S405 generates a VOB (video object) from the program stream.

A step S407 following the step S406 controls the DVD drive device 115 to record the VOB generated by the step S406 on the DVD 114 from the on-disc recording start point. Then, the step S407 updates the on-disc recording start point into coincidence with an on-disc point immediately following the place of the recorded VOB.

A step S408 subsequent to the step S407 extracts video object information from the VOB generated by the step S406. The extracted video object information is composed of time information, address information, and discontinuous point information. The step S408 writes the video object information into the RAM within the recording signal processor 150 or the controller 160.

A step S409 following the step S408 accesses the input signal processor 102 to decide whether or not the input signal corresponding to one VTS is being fed thereto, that is, whether or not the input signal terminates. When the input signal is being fed to the input signal processor 102, the program returns from the step S409 to the step S404. On the other hand, when the input signal terminates, the program advances from the step S409 to a step S410.

In the case where the program advances from the step S409 to the step S410, all VOBs constituting a VOBS (video object set) of the present VTS have been recorded on the DVD 114 by the repetitive execution of the step S407. Furthermore, video object information for the VOBS, that is, video object information for all the VOBs constituting the VOBS, has been prepared in the RAM within the recording signal processor 150 or the controller 160 by the repetitive execution of the step S408.

The step S410 reads out the video object information for all the VOBs in the present VTS from the RAM within the recording signal processor 150 or the controller 160. In other words, the step S410 retrieves the video object information for all the VOBs in the present VTS. The step S410 generates VTSI and VTSI(BUP) for the VOBS of the present VTS from the retrieved video object information. The generated VTSI is management information or control information for the VOBS. The generated VTSI(BUP) is a backup of the generated VTSI.

A step S411 subsequent to the step S410 controls the DVD drive device 115 to record the VTSI generated by the step S410 on a head of an unoccupied portion (a usable portion) of the VTSI recording region in the DVD 114 which has been secured by the step S402. In addition, the step S411 controls the DVD drive device 115 to record the VTSI(BUP) on a portion of the DVD 114 which immediately follows the place of the last recorded VOB. Then, the step S411 updates the on-disc recording start point into coincidence with an on-disc point immediately following the place of the recorded VTSI(BUP).

A step S412 following the step S411 decides whether or not “n” VTSs have been recorded on the DVD 114. In the case where “n” VTSs have been recorded on the DVD 114, the program advances from the step S412 to a step S413. Otherwise, the program returns from the step S412 to the step S403.

The step S413 generates a VMG from signals representative of conditions of the recorded “n” VTSs. The generated VMG includes management information for the entire DVD 114, that is, control and playback information for the entire DVD 114 or information for controlling the recorded “n” VTSs. Then, the step S413 controls the DVD drive device 115 to record the VMG on the recording region in the DVD 114 for a VMG which has been secured by the step S401. After the step S413, the current execution cycle of the program segment ends.

The recording apparatus 1 can sequentially record real-time information inclusive of video data, audio data, or audio-visual data on a DVD 114. The number of VTSs recorded on a DVD 114 by the recording apparatus 1 can be greater than the upper limit number prescribed by the DVD-Video standards.

According to the DVD+R standards, the upper limit of the track number is 16 per session so that only VTSs corresponding to 7 titles can be recorded on one DVD+R. The DVD 114 in FIG. 2 and 3 may be a DVD+R. The recording apparatus 1 provides the DVD+R 114 with a 3-track structure (see FIG. 4), and can record VTSs corresponding to 8 or more titles on the DVD+R 114.

### Second Embodiment

A second embodiment of this invention is similar to the first embodiment thereof except for design changes described hereafter.

In the second embodiment of this invention, the step S410 (see FIG. 7) writes the generated VTSI into the RAM within the recording signal processor 150 or the controller 160.

The step S411 (see FIG. 7) controls the DVD drive device 115 to record the VTSI(BUP) on the DVD 114. Then, the step S411 updates the on-disc recording start point. At the step S411, the VTSI generated by the step S410 is not recorded on the DVD 114.

The step S413 reads out the “n” VTSI for all the recorded “n” VTSs from the RAM within the recording signal processor 150 or the controller 160. The “n” VTSI are expressed as VTSI#1, VTSI#2, . . . , VTSI#n. The step S413 controls the DVD drive device 115 to record the VMG on the recording region in the DVD 114 for a VMG which has been secured by the step S401. In addition, the step S413 controls the DVD drive device 115 to record the “n” VTSI on the recording region in the DVD 114 for “n” VTSI which has been secured by the step S402.

### Third Embodiment

A third embodiment of this invention is similar to the second embodiment thereof except for design changes described hereafter.

In the third embodiment of this invention, the step S401 (see FIG. 7) controls the DVD drive device 115 to provide or secure a recording region on the DVD 114 for not only a VMG but also “n” VTSI. The secured recording region corresponds to a combination of the recording regions 31 and 32 in FIG. 6. After the step S401, the program advances to the step S403 (see FIG. 7). Accordingly, the step S402 (see FIG. 7) is omitted.

The step S413 (see FIG. 7) controls the DVD drive device 115 to record the VMG on a former part of the recording region in the DVD 114 for a VMG and “n” VTSI which has been secured by the step S401. In addition, the step S413 controls the DVD drive device 115 to record the “n” VTSI on the remaining part of the secured recording region in the DVD 114.

According to the third embodiment of this invention, the VMG, the “n” VTSI, the VOBs, and the “n” VTSI(BUP) are recorded on two tracks in the DVD 114. Basically, the resultant recorded data structure in the DVD 114 conforms with the DVD-Video standards.

### Fourth Embodiment

A fourth embodiment of this invention is similar to the first embodiment thereof except that the DVD 114 and the DVD drive device 115 are replaced by a recordable disc of another type and a drive device therefor.

What is claimed is:

1. An apparatus for recording information on a recording disc, comprising:
first means for generating a program stream from input video data;
second means for securing a recording area in a first track on the recording disc;
third means for generating video object sets from the program stream generated by the first means;
fourth means for recording the video object sets generated by the third means on a second track on the recording disc, the second track being separate from the first track;
fifth means for generating video title management information pieces corresponding to the respective video object sets generated by the third means; and
sixth means for recording the video title management information pieces generated by the fifth means on the recording area secured by the second means.

2. An apparatus as recited in claim 1, wherein the fourth means records the video object sets on the second track while the sixth means records the video title management information pieces on the recording area secured by the second means.

3. An apparatus as recited in claim 1, wherein the fourth means records the video object sets on the second track before the sixth means records the video title management information pieces on the recording area secured by the second means.

4. An apparatus as recited in claim 1, further comprising:
seventh means for securing a recording area in a third track on the recording disc, the third track being separate from the first and second tracks;
eighth means for generating a video manager related to the recorded video object sets and the recorded video title management information pieces; and
ninth means for recording the video manager generated by the eighth means on the recording area secured by the seventh means.

5. A method of recording information on a recording disc, comprising the steps of:
a) generating a program stream from input video data;
b) securing a recording area in a first track on the recording disc;
c) generating video object sets from the program stream generated by the step a);
d) recording the video object sets generated by the step c) on a second track on the recording disc, the second track being separate from the first track;
e) generating video title management information pieces corresponding to the respective video object sets generated by the step c); and
f) recording the video title management information pieces generated by the step e) on the recording area secured by the step b).

6. A method as recited in claim 5, wherein the step d) records the video object sets on the second track while the step f) records the video title management information pieces on the recording area secured by the step b).

7. A method as recited in claim 5, wherein the step d) records the video object sets on the second track before the step f) records the video title management information pieces on the recording area secured by the step b).

8. A method as recited in claim 5, further comprising the steps of:
g) securing a recording area in a third track on the recording disc, the third track being separate from the first and second tracks;
h) generating a video manager related to the recorded video object sets and the recorded video title management information pieces; and
i) recording the video manager generated by the step h) on the recording area secured by the step g).
